(19) United States
(12) Patent Application Publication
(10) Pub. No.: US 2024/0149430 A1
(43) Pub. Date: May 9, 2024

(54) TOOLBOX

(71) Applicant: LIH YANN INDUSTRIAL CO., LTD., Taichung City (TW)

(72) Inventors: Ying-Chieh Liao, Taichung City (TW); Yu-Kuo Liao, Taichung City (TW)

(21) Appl. No.: 18/501,835

(22) Filed: Nov. 3, 2023

(30) Foreign Application Priority Data
Nov. 4, 2022 (TW) 111212096

(51) Int. Cl. B25H 3/02; B25H 3/06; B65D 21/02; B65D 43/16

(52) U.S. Cl. CPC B25H 3/02; B25H 3/06; B65D 21/0223; B65D 43/164; B65D 2251/1058; B65D 2543/00194

(57) ABSTRACT

A toolbox is provided, including a main body, an inner tray and a plurality of first connecting mechanisms. The main body includes a box body and a cover body. The box body includes a surface and a receiving groove extending concavely from the surface. The inner tray is disposed on the box body and includes a lip portion and at least one receiving portion. The lip portion is laterally connected with the at least one receiving portion and abutted against the surface. The lip portion has at least two dodge notches extending concavely from a circumferential edge of the lip portion. The plurality of first connecting mechanisms respectively include a first connecting member. In a direction lateral to an opening direction of the receiving groove, each said first connecting member is located in an area corresponding to an opening of one of said dodge notches.

### BACKGROUND OF THE INVENTION

### Field of the Invention

The present invention relates to a toolbox.

### Description of the Prior Art

A toolbox is used to store hand tools, metal parts, etc., providing good portability and protection. The conventional toolbox is made of metal and is heavy, therefore, toolboxes made of plastic or plastic partially reinforced with metal are developed.

The conventional toolbox is improved in material but still has a traditional configuration in structure. A side of the conventional toolbox has hinges, and the other side of the conventional toolbox has buckles, which is inconvenient to use. For example, the toolbox should be placed on a position where allows a cover body of the toolbox to be opened; and the cover body takes up too much space when being opened, which greatly reduces a working space.

The present invention is, therefore, arisen to obviate or at least mitigate the above-mentioned disadvantages.

### SUMMARY OF THE INVENTION

The main object of the present invention is to provide a toolbox, having a cover body can be opened in different ways to meet different requirements.

To achieve the above and other objects, the present invention provides a toolbox, including: a main body, an inner tray and a plurality of first connecting mechanisms. The main body includes a box body and a cover body movably covered on the box body. The box body includes a surface and a receiving groove concavely extending from the surface. The inner tray is disposed on the box body and includes a lip portion and at least one receiving portion. The lip portion is laterally connected with the at least one receiving portion and abutted against the surface. The at least one receiving portion is disposed within the receiving groove, and the lip portion has at least two dodge notches extending concavely from a circumferential edge of the lip portion in a direction lateral to an opening direction of the receiving groove. The plurality of first connecting mechanisms respectively include a first connecting member, a first pivoting unit disposed on the cover body, a second pivoting unit disposed on the box body, a first engaging unit disposed on the cover body and a second engaging unit disposed on the box body. Each said first pivoting unit is removably and pivotally connected with one said second pivoting unit. Each said first connecting member includes a first end portion, a connecting section and a second end portion connected in sequence. One of the first end portion and the second end portion is pivotally connected with the first engaging unit, and the other of the first end portion and the second end portion is removably connected with the second engaging unit. In the direction lateral to the opening direction of the receiving groove, each said first connecting member is located in an area corresponding to an opening of one of the at least two dodge notches.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a stereogram of a preferable embodiment of the present invention when a cover body is opened;

FIG. 4 is an enlargement of area A of FIG. 3;

FIG. 5 is an enlargement of area B of FIG. 3;

FIG. 6 is a top view of FIG. 3;

FIG. 7 is a partial side view of FIG. 6; and

FIG. 8 is a diagram showing operation of second connecting mechanisms according to a preferable embodiment of the present invention.

### DETAILED DESCRIPTION OF THE PREFERRED EMBODIMENTS

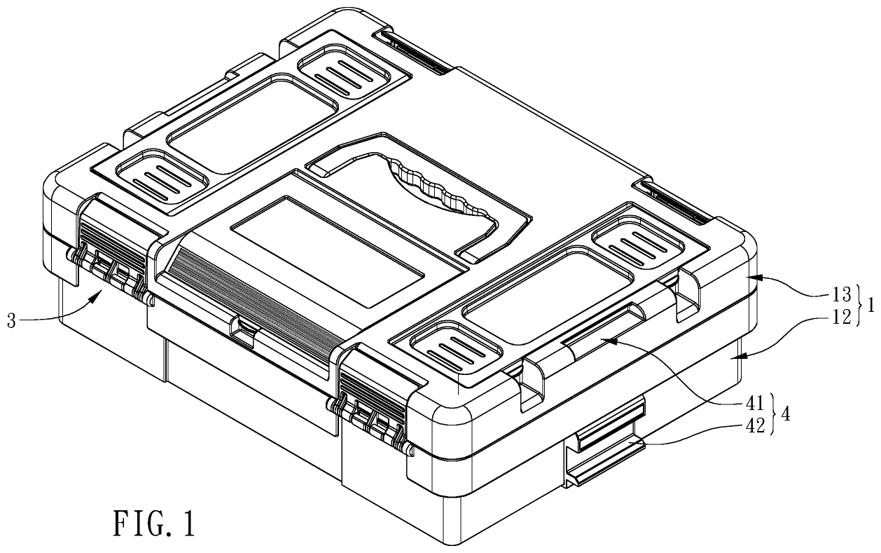

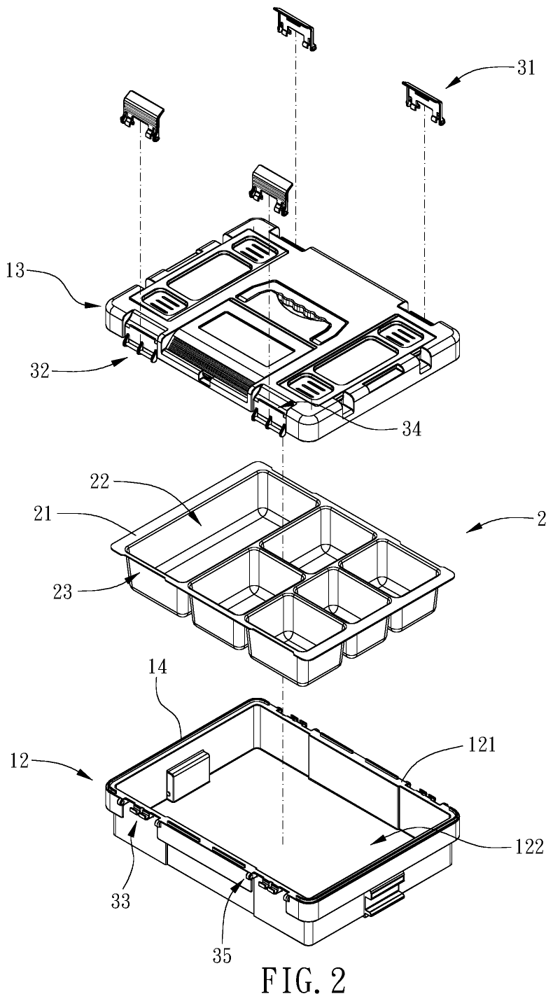

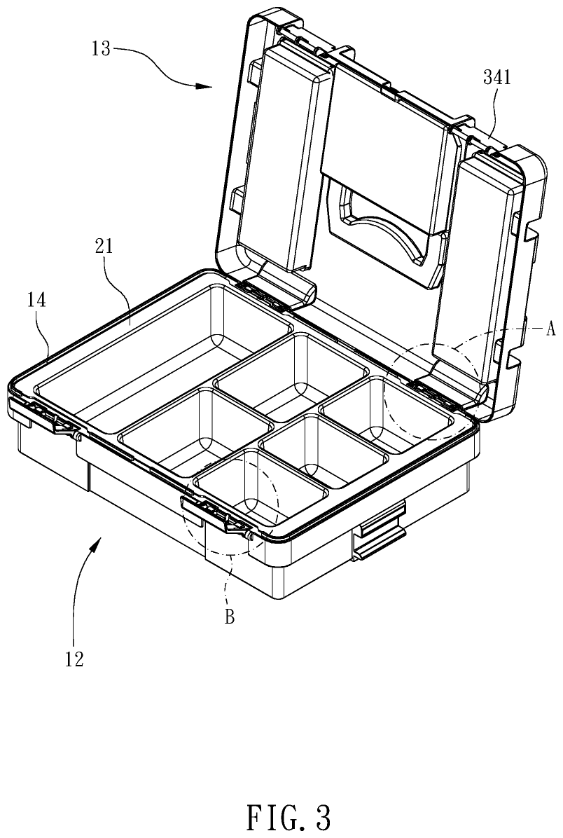

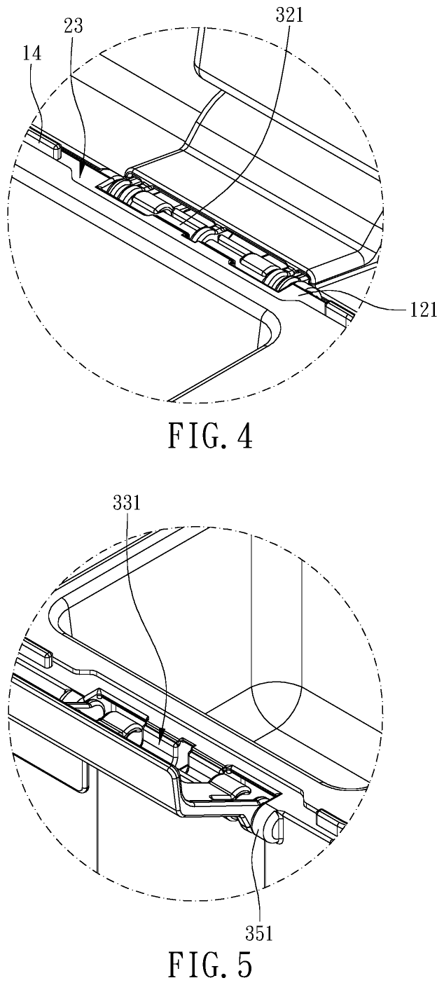

Please refer to FIGS. 1 to 8 for a preferable embodiment of the present invention. A toolbox of the present invention includes a main body 1, an inner tray 2 and a plurality of first connecting mechanisms 3.

The main body 1 includes a box body 12 and a cover body 13 movably covered on the box body 12. The box body 12 includes a surface 121 and a receiving groove 122 concavely extending from the surface 121. The inner tray 2 is disposed on the box body 12 and includes a lip portion 21 and at least one receiving portion 22. The lip portion 21 is laterally connected with the at least one receiving portion 22 and abutted against the surface 121. The at least one receiving portion 22 is disposed within the receiving groove 122, and the lip portion 21 has at least two dodge notches 23 extending concavely from a circumferential edge of the lip portion 21 in a direction lateral to an opening direction of the receiving groove 122.

In this embodiment, the inner tray 2 is a blister tray, and a number of the at least one receiving portion 22 is plural. At least two of said receiving portions 22 are of different types, which allows a user to classify objects received therewithin by sizes, types, or the like. In addition, the inner tray 2 is removably disposed on the box body 12 so as to be convenient to replace to meet different requirements.

The plurality of first connecting mechanisms 3 respectively include a first connecting member 31, a first pivoting unit 32 disposed on the cover body 13, a second pivoting unit 33 disposed on the box body 12, a first engaging unit 34 disposed on the cover body 13 and a second engaging unit 35 disposed on the box body 12. Each said first pivoting unit 32 is removably and pivotally connected with one said second pivoting unit 33. Each said first connecting member 31 includes a first end portion 312, a connecting section 313 and a second end portion 314 connected in sequence. One of the first end portion 312 and the second end portion 314 is pivotally connected with one said first engaging unit 34, and the other of the first end portion 312 and the second end portion 314 is removably connected with one said second engaging unit 35. In this embodiment, each said first pivoting unit 32 is a pivot 321, each said second pivoting unit 33 is a pivot groove 331, each said first engaging unit 34 is a convex engaging portion 341, each said second engaging unit 35 is a pivoting ear 351, and each said first connecting member 31 is a buckle 311. Each said pivot 321 is detachably and pivotally disposed within one said pivot groove 331, and each said buckle 311 is pivotally connected with one said pivoting ear 351 and engageable with one said convex engaging portion 341.

Moreover, when the plurality of first connecting mechanisms 3 are disposed on two opposite sides of the main body 1, the cover body 13 can be opened in two ways to meet different requirements. When all of said first connecting members 31 disposed on a side of the main body 1 are disengaged from respective said second engaging units 35, the cover body 13 can be opened laterally relative to the box body 12. When all of said first connecting members 31 disposed on the main body 1 are disengaged from respective said second engaging units 35, the cover body 13 can be removed from the box body 12.

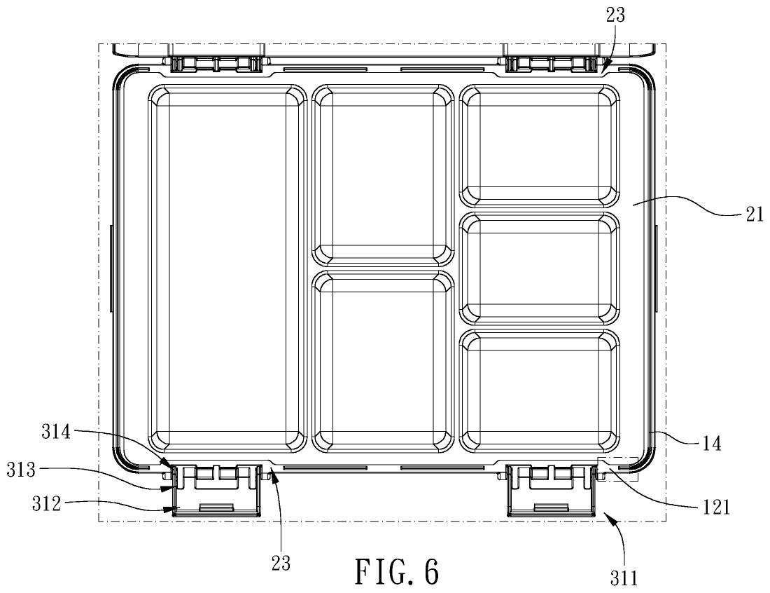

Furthermore, in the direction lateral to the opening direction of the receiving groove 122, each said first connecting member 31 is located in an area corresponding to an opening of one of the at least two dodge notches 23, as shown in FIGS. 5 and 6. Therefore, each said first connecting member 31 is free of interference with the lip portion 21 during swinging, which allows each said first connecting member 31 to be moved smoothly.

Preferably, a minimum width of each of the at least two dodge notches 23 is larger than a maximum width of one said first connecting member 31. In the direction lateral to the opening direction of the receiving groove 122, a width of each of the at least two dodge notches 23 is gradually increased in a direction toward one said first connecting member 31, which provides a sufficient moving space to each said first connecting member 31 and allows the inner tray 2 to be used with different types of said first connecting members 31.

The box body 12 further includes a restricting rib 14, and the restricting rib 14 protrudes from the surface 121. The restricting rib 14 is interfereable with the lip portion 21 in the direction lateral to the opening direction of the receiving groove 122. Therefore, the restricting rib 14 restricts a movement of the inner tray 2 relative to the box body 12 and prevents the lip portion 21 from being pressed unexpectedly.

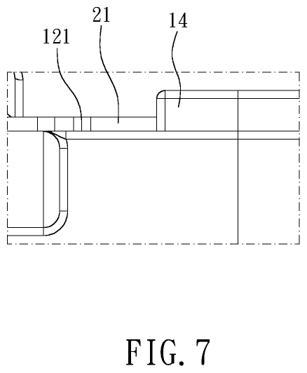

In this embodiment, the restricting rib 14 extends along a contour of the surface 121, and based on the surface 121, a height of the restricting rib 14 is at least 2 times of a thickness of the lip portion 21 so that the restricting rib 14 effectively blocks the lip portion 21 from being impacted or squeezed, as shown in FIG. 7. In addition, in the direction lateral to the opening direction of the receiving groove 122, the restricting rib 14 is located out of the area corresponding to the opening of one of the at least two dodge notches 23.

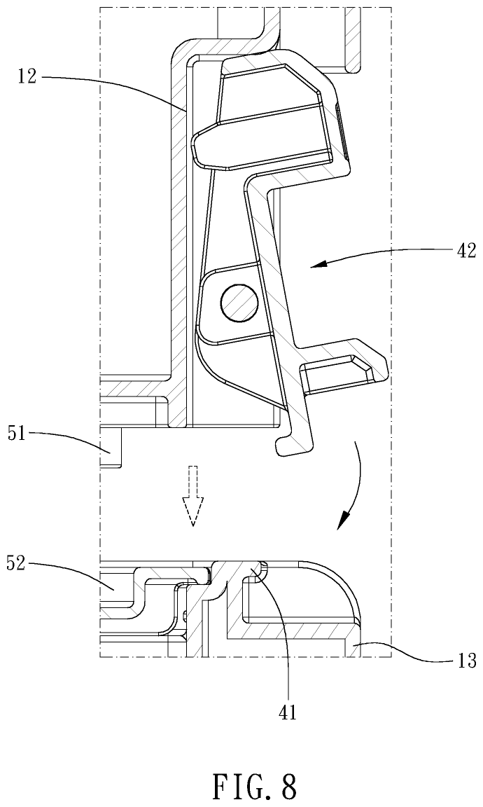

The toolbox further includes a plurality of second connecting mechanisms 4, and each of the plurality of second connecting mechanisms 4 includes a third engaging unit 41 and a second connecting member 42. Each said third engaging unit 41 is disposed on one of the cover body 13 and the box body 12, and each said second connecting member 42 is movably disposed on the other of the cover body 13 and the box body 12. When two said toolboxes are stacked up, said second connecting members 42 of one of the two said toolboxes are configured to be operated externally and connected with said third engaging units 41 of the other of the two said toolboxes so that the two said toolboxes are connected into a whole, as shown in FIG. 8, which is convenient to be carried and moved.

The toolbox further includes an embedding mechanism, and the embedding mechanism includes at least one projecting portion 51 and at least one recessed portion 52. One of the at least one projecting portion 51 and the at least one recessed portion 52 is disposed on the cover body 13, and the other of the at least one projecting portion 51 and the at least one recessed portion 52 is disposed on the box body 12. When one of the two said toolboxes is stacked on the other of the two said toolboxes, the at least one projecting portion 51 one of the two said toolboxes is embedded within the at least one recessed portion 52 of the other of the two said toolboxes so as to increase stacking stability.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A toolbox, including:
a main body, including a box body and a cover body movably covered on the box body, the box body including a surface and a receiving groove concavely extending from the surface;
an inner tray, disposed on the box body, including a lip portion and at least one receiving portion, the lip portion laterally connected with the at least one receiving portion and abutted against the surface, the at least one receiving portion disposed within the receiving groove, the lip portion having at least two dodge notches extending concavely from a circumferential edge of the lip portion in a direction lateral to an opening direction of the receiving groove; and
a plurality of first connecting mechanisms, respectively including a first connecting member, a first pivoting unit disposed on the cover body, a second pivoting unit disposed on the box body, a first engaging unit disposed on the cover body and a second engaging unit disposed on the box body, each said first pivoting unit removably and pivotally connected with one said second pivoting unit, each said first connecting member including a first end portion, a connecting section and a second end portion connected in sequence, one of the first end portion and the second end portion pivotally connected with one said first engaging unit, the other of the first end portion and the second end portion removably connected with one said second engaging unit; in the direction lateral to the opening direction of the receiving groove, each said first connecting member located in an area corresponding to an opening of one of the at least two dodge notches.

2. The toolbox of claim 1, wherein the box body further includes a restricting rib, the restricting rib protrudes from the surface, and the restricting rib is interfereable with the lip portion in the direction lateral to the opening direction of the receiving groove.

3. The toolbox of claim 2, wherein the restricting rib extends along a contour of the surface.

4. The toolbox of claim 3, wherein in the direction lateral to the opening direction of the receiving groove, the restricting rib is located out of the area corresponding to the opening of one of the at least two dodge notches.

5. The toolbox of claim 2, wherein based on the surface, a height of the restricting rib is at least 2 times of a thickness of the lip portion.

6. The toolbox of claim 1, wherein each said first pivoting unit is a pivot, each said second pivoting unit is a pivot groove, each said first engaging unit is a convex engaging portion, each said second engaging unit is a pivoting ear, each said first connecting member is a buckle, each said pivot is detachably and pivotally disposed within one said pivot groove, and each said buckle is pivotally connected with one said pivoting ear and engageable with one said convex engaging portion.

7. The toolbox of claim 1, further including a plurality of second connecting mechanisms, wherein each of the plurality of second connecting mechanisms includes a third engaging unit and a second connecting member, each said third engaging unit is disposed on one of the cover body and the box body, each said second connecting member is movably connected with the other of the cover body and the box body; and when two said toolboxes are stacked up, said second connecting members of one of the two said toolboxes are configured to be operated externally and connected with said third engaging units of the other of the two said toolboxes so that the two said toolboxes are connected into a whole.

8. The toolbox of claim 1, further including an embedding mechanism, wherein the embedding mechanism includes at least one projecting portion and at least one recessed portion, one of the at least one projecting portion and the at least one recessed portion is disposed on the cover body, the other of the at least one projecting portion and the at least one recessed portion is disposed on the box body; when one of the toolbox is stacked on another one of the toolbox, the at least one projecting portion of one of said toolboxes is embedded within the at least one recessed portion of another one of the said toolboxes.

9. The toolbox of claim 1, wherein in the direction lateral to the opening direction of the receiving groove, a width of each of the at least two dodge notches is gradually increased in a direction toward one said first connecting member.

10. The toolbox of claim 4, wherein based on the surface, a height of the restricting rib is at least 2 times of a thickness of the lip portion; each said first pivoting unit is a pivot, each said second pivoting unit is a pivot groove, each said first engaging unit is a convex engaging portion, each said second engaging unit is a pivoting ear, each said first connecting member is a buckle, each said pivot is detachably and pivotally disposed within one said pivot groove, and each said buckle is pivotally connected with one said pivoting ear and engageable with one said convex engaging portion; the toolbox further includes a plurality of second connecting mechanisms and an embedding mechanism, each of the plurality of second connecting mechanisms includes a third engaging unit and a second connecting member, each said third engaging unit is disposed on one of the cover body and the box body, each said second connecting member is movably connected with the other of the cover body and the box body; and when two said toolboxes are stacked up, said second connecting members of one of the two said toolboxes are configured to be operated externally and connected with said third engaging units of the other of the two said toolboxes so that the two said toolboxes are connected into a whole; the embedding mechanism includes at least one projecting portion and at least one recessed portion, one of the at least one projecting portion and the at least one recessed portion is disposed on the cover body, the other of the at least one projecting portion and the at least one recessed portion is disposed on the box body; when one of the two said toolboxes is stacked on the other of the two said toolboxes, the at least one projecting portion of one of the two said toolboxes is embedded within the at least one recessed portion of the other of the two said toolboxes; in the direction lateral to the opening direction of the receiving groove, a width of each of the at least two dodge notches is gradually increased in a direction toward one said first connecting member; the inner tray is a blister tray; a number of the at least one receiving portion is plural, and at least two of said receiving portions are of different types; the inner tray is removably disposed on the box body; and a minimum width of each of the at least two dodge notches is larger than a maximum width of one said first connecting member.
